(19) United States
(12) Patent Application Publication
(10) Pub. No.: US 2004/0177150 A1
(43) Pub. Date: Sep. 9, 2004

(54) Method for filter selection and array matching

(76) Inventor: Kiril Kogan, Petach-Tikva (IL)

Correspondence Address: Landon Stark, Cantwell & Paxton, Suite 210, 2011 Crystal Drive, Arlington, VA, 22202-3709, US

(21) Appl. No.: 10/482,131

(22) PCT Filed:
(86) PCT No.: PCT/IL02/00515

Related U.S. Application Data
(60) Provisional application No. 60/300,962, filed on Jun. 26, 2001.

(51) Int. Cl. G06F 15/16

(52) U.S. Cl. 709/229

(57) ABSTRACT

A communications network having a multi-staged data filter system for selecting and matching filters to the information flow. The multi-staged data filter system operates to handle information flow by matching attributes of the information with filter arrays, by conducting a search in accordance with binary tree algorithm, said binary tree constructed from a policy table containing a list of related filter arrays arranged in a particular sequence.

### FIELD OF THE INVENTION

The present invention relates to an improved method for multi-stage array matching, especially useful for the fast and economical determination of message priorities in a computerized communication network, in data processing and in related areas, through the use of filters. More particularly, the present invention relates to a method for the selection of a small number of tables comprising arrays from among a large number of such tables.

### BACKGROUND OF THE INVENTION

A message according to Internet Protocol (“IP” hereinbelow) is sent in the form of one or more packets, each packet including a header and data. Each IP header comprises several fields which include routing and other particulars of the packet, permitting the reassembly of the communicated packets back into the original message. The header array contains particulars which can also be used for determining how a message should be handled, such as its routing or its priority, according to selectable criteria. Communication protocols other than IP exist, and may utilize different methods for routing and for other purposes.

In general, “filters” are tables of arrays used for the determination of handling criteria and for the classification of “flows”—series of packets that have a common attribute. Filtering occurs when at least some of these header arrays are found to match with corresponding arrays in filters which are applied to them. Known, packet prioritizing methods are based on filter matching wherein only a small number of packet header fields or arrays are examined and used as the basis for selecting a number of filters from among a large number of filters stored in a database, while ignoring the information stored in the remaining fields. The selected filters are then used for the handling of the packets. This method is used because the computational load required to perform sequential matching of all of the fields for the selection of the applicable filters is excessive. Presently the speed of matching of multi-arrayed filters from a database of a large number of similar filters is less than satisfactory.

Criteria for the classification and the handling of messages are typically established by network managers and by service providers. These criteria may call for an analysis and comparison of the message header particulars and of the message data, also referred to herein as contents.

Today, known classification methods underutilize the available information for classifying flows. This is particularly so with respect to large network environments where each of the millions of incoming packets has to have thousands of tables of arrays applied to it, thereby causing a tremendous load on processors or severe logjams in the system.

The resources available to the service providers for the processing of packet communications are limited. This applies also to the memory available for the filter matching. It is known that the general lower boundary of search time in k-dimensional ranges, when memory is limited to Ω (n), is:

Ω{[log(n)]^{k-1}} (1)

where

Ω Order of magnitude;

n: The number of filters in the database; and

k: The number of fields in a header, the number of conditions of a filter.

Notice that according to eq. (1), the order of magnitude of the search times for k=1, 2, corresponding to one or two matched arrays in a filter, are short, as only for these two cases the required search time is not an exponential function of the number of arrays. Note also that the search time increases exponentially if the number of dimensions, or the number of arrays matched in the search, is more than 2. It is therefore clear that in order to benefit from this property of one or two search arrays, the search and the matching are preferably conducted in at least two stages.

The simplest array matching method is to scan consecutively all of the filters in a computer-accessible database and select a filter according to the the particulars of the message, such as are found in the message header fields. Such a scanning method is both lengthy and memory intensive, as it requires the scanning of all of the database filters.

Thus, there is a need for a fast array matching algorithm for selection of at least one filter that includes arrays from among a collection of filters, where the filters may be stored in a database. Furthermore, the algorithm selection should be based on the values of the arrays and should be able to be adjusted for different network environments.

### SUMMARY OF THE INVENTION

Accordingly, it is a principal object of the present invention to overcome the limitations of the prior art and provide a method for selecting a small number of tables comprising arrays from a large number of such tables and further matching the tables to corresponding packets.

It is another object of the present invention to provide a method for fast and multi-stage selection from among a collection of filters stored in a database,according to selectable criteria, of at least one filter that includes arrays.

It is yet another object of the present invention to provide a method for fast multi-stage selection of at least one filter that includes arrays from among a collection of filters based on the values of said arrays.

It is still another object of the present invention to provide a method for fast multi-stage array selection that will enhance network performance.

In accordance with a preferred imbodiement of the present invention, there is provided a filter selection and array matching method comprising a binary sort tree building (also referred to hereinafter as “BTB”) stage, implemented by an algorithm. During the BTB stage a plurality of binary sort trees (also referred to hereinafter as “BST”) are built from an identical number of groups of arrays selected from a database of filters stored in a policy table. The next stage is a filter selection process (also referred to hereinafter as “FS”) in which a subset of filters are selected from among the database of filters. The FS is performed using the BST built in the BTB stage.

Once a group of filters has been selected from among the database filters, they may be, for example, applied to packet headers for determining the handling of these packets. According to the present invention, look-up, can now be conducted on the smaller number of filters from the selected group only, rather than on a full database of filters.

In accordance with the principles of the present invention, the binary sort tree (BST) scheme is used for the designation and the fast retrieval of binary arrays. More specifically, the BST is used for the sorting and grouping of filters, based on one of their arrays or conditions. A BST starts with a root node, located at the top of its graphical representation. From the root node of the BST, up to two pointers may point diagonally downwards into a first level: One pointer points down and to the right, if the first binary digit of any of said arrays is “1”, to form a first node, and another pointer—points down and to the left, if the first binary digit of any of said arrays is “0”, to form a second node. From each one of these two nodes up to two new pointers are generated by the algorithm, and point to form a second level, representing the binary values of the second binary digit of any of the arrays. The node formed down and right node represents a binary value of “1”, and the node formed down and left represents a binary value of “0” of any of the arrays, forming a total of four possible second level nodes for two binary digits, etc. Conversely, each j-digits binary number or array, can be represented by one node among 2^{j} possible nodes (Fⱼ: The j^{th} filter in a database) located j levels below the root and reached by following a path comprising a sequence of diagonally right or left pointers according to the array sequence of binary digits. The last node represented by an array is the node reached by the last binary digit.

In the present invention, an array or a filter field is categorized into one of four match categories:

an exact match—wherein the field within the filter comprises binary digits only;

a prefix match—wherein the field within the filter comprises a number of preceding binary digits, followed by a single “*”, for matching the remaining bits. In order to be handled by this invention, “any” may not be followed by a binary digit, but it may be preceded by any number of them, including none, wherein “any” becomes the only term of the filter;

a range match—wherein the field within the filter permits the matching of values bound by an upper value and by a lower valu which is not zero; and

an “any” match—wherein the field within the filter comprises only of a “*”.

These four match categories are reducible to three. A single range match filter can be represented as the logical “OR” of up to 2w prefix match filters, wherein w is the number of bits in the filter's field. This representation of range arrays is used to replace range arrays with prefix arrays, and consequently, in accordance with the present invention, only three match categories need to be considered.

In this invention, an “any” digit before binary bits (for example *000100) represents a “range” array while an “any” digit after binary digits (for example 100001*) represents a prefix array. As described above, range arrays in this invention are translated to prefix arrays, and therefore, only arrays with “any” digit that is not followed by binary digits (prefix array) will be handled.

According to another embodiment of the present invention, during the BTB stage at least two conditions are selected from a plurality of conditions, stored in a policy table, for further building two BST (one for every condition), thus achieving maximum filter splitting. A particular array from each one of the database filters is arranged to form the nodes of a BST as further described hereinbelow. This procedure is repeated for all of the arrays stored at the conditions which were chosen at the beginning of the BTB procces. The nodes of one BST are initialized with arrays from the suitable filter condition with pointers which point to corresponding nodes of the same filter placed at the second BST, thus presenting the corresponding arrays of the same filter conditions placed in the policy table.

Once BST are established, a flow can be matched within a boundary-limited sort time to its appropriate filter, by excluding as many un-matched filters from the table, using the data stored at the two BST.

The selection is based on a sorting process activated in parallel on both of the BST. During the sorting process, filters that are found to match a corresponding flow are added, based on their known cost, to a new filter list. The selected filters placed on the new filter list are further sorted and matched to the flow by any other known algorithm.

Still another embodiment of the present invention involves building, during the BTB stage, another pair of BST from the first group of filters to form a sub-group of filters, then a sub-sub group, and so on. In this fashion, the number of filters to be applied to a corresponding packet header is decreased. The database BST are built once and need only be changed when changes in the database occur.

Another alternative embodiment of the present invention involves building, during the BTB stage, several pairs of BST as shown hereinabove, using each pair to choose a group of filters and then select only those filters that are part of all of these groups.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding sections or elements throughout, and in which:

FIG. 1 is an exemplary embodiment of a policy table utilized in implementing a preferred method of the present invention;

FIG. 2 is an exemplary description of a binary sort tree useful in implementing a preferred method of the present invention;

FIG. 3 is a flowchart of the algorithm for building two binary sort trees featuring destination field arrays and source field arrays, and pointers between them; and

FIG. 4 is a depiction of an exemplary filter selection process operated in accordance with principles of the present invention.

### DETAILED DESCRIPTION OF THE PREFERRED EMBODIMENTS

In the detailed description of exemplary embodiments which follow, the following terms should generally be understood as specified hereinbelow unless otherwise specified:

Flow—a series of packets having common attributes.

Flow attributes—flow data that can be used for distinguishing between flows.

Connection—logical link between a client and a server, established to communicate a flow and deleted after the communication ends. A connection serves a flow.

Condition—a criterion to be compared to a flow attribute for the partial establishment of handling criteria of that flow. Every condition can be represented by an array.

Cost—a condition necessary for determining the priority of filters during the filter matching process.

Filter—a list of conditions for the determination of the handling criteria and for the classification of flows. A filter is a table including one or more arrays. More than one filter may be applied to a flow.

Filter matching—the determination of the preferred filter for the handling of a flow. The matching of a filter involves the determination of a cost which varies among filters.

Action—an operation on network traffic specified by a condition.

Policy—a list of related rules.

Rule—coupling of conditions and actions.

Session—software object for the handling of flows, the period during which a connection exists.

Array—a sequence of binary representations. Every condition can be represented by an array.

Policy Table—a group of related arrays arranged in a particular sequence. Arrays comprising a filter need not be of the same size. A filter is represented by a table.

“Any” digit—a designation within an array, replacing any missing elements within a particular part of an array or in all of it, so that any element could be inserted in the particular part of the array or in all of it. “Any” digit is designated hereinbelow by an “*”.

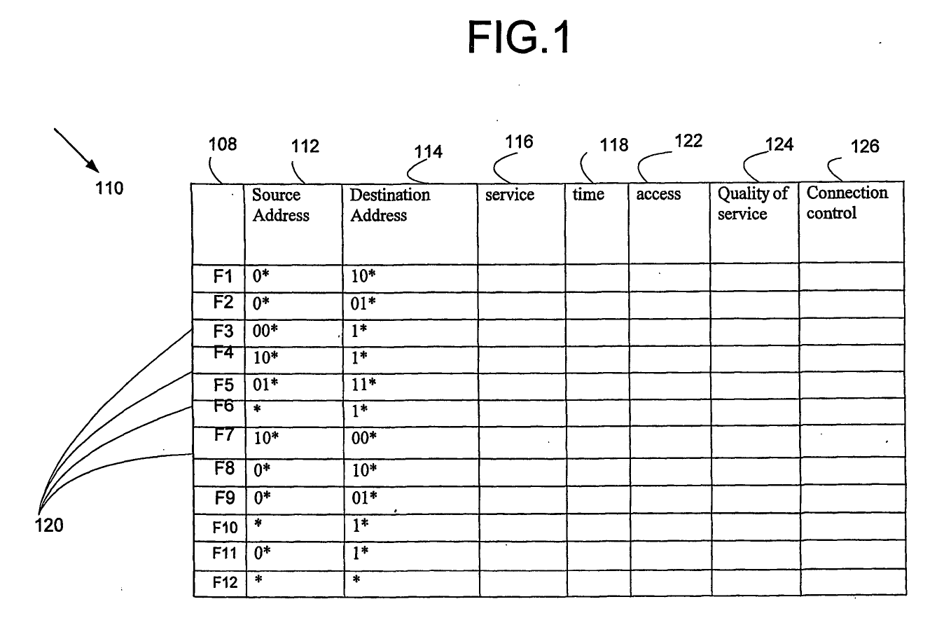

Referring now to FIG. 1, there is shown an exemplary embodiment of a policy table 110 according to the present invention, comprising a list of filters F1-F12 120 listed in the filter name column 108. Each of these filters is defined by its conditions, such as the source address 112, destination address 114, service 116, and time 118. The filter is also defined by a list of actions, such as access 122, quality of service 124 and connection control 126. Each set of conditions 114, 116, 118 and actions 122, 124, 126, defines a rule, which is associated with the list of filters 120.

In the example shown in FIG. 1, the action fields that were chosen are the source address 112, and the destination address 114 fields. The selection of only these two actions is based on heuristic considerations, past experience and future assessments, to enable the algorithm to exclude as many filters at the first FS stage.

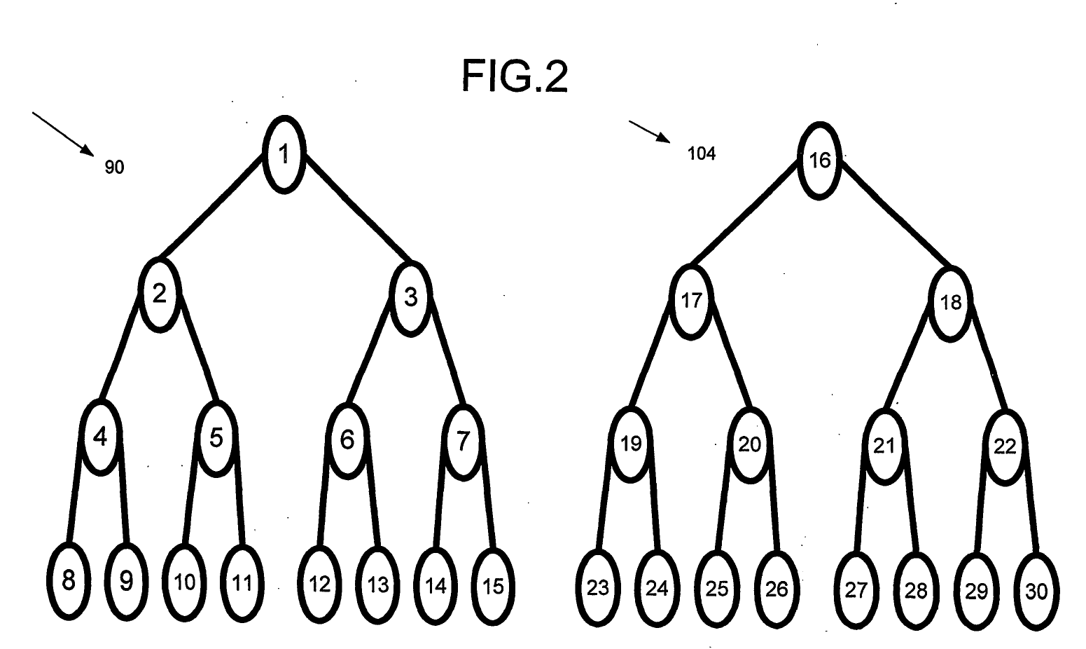

With reference to FIG. 2, there is shown an exemplary description of a binary BST built from policy table 110. Two BST 90 and 104 are built, based on known BST rules, and according to the database stored in policy table 110 as described in FIG. 1. According to BST rules, the maximal depth of a BST in this invention is up to w levels (where w is the word or header size in bits). In this exemplary case, the maximum depth possible is up to thirty two levels. The number of bits in this exemplary field (b) (where b is the number of bits in a prefix field of a filter), is 3 levels. The level of the root is 0, thus only three levels of the BST, with first, second and third level arrays need to be depicted.

As shown, at roots 1,16 of the two BST 90, 104 an “any” digit is placed. The BST is constructed, starting from the root and pointing with two pointers to the first level—one pointer pointing down and to the right (3 at the source BST 90, and 18 at the destination BST 104) and the other pointer pointing down to the left (2 at the source BST 90 , and 17 at the destination BST 104). From each one of these four nodes, up to two new pointers point to form a second level, representing the binary values of the second binary digit of any of the arrays. Thus, one pointer points down and right to a node, and the other pointer points down and left to a node, forming a total of eight possible second level nodes (4, 5, 6 and 7 at the source BST 90 and 19, 20, 21 and 22 at the destination BST 104).

Conversely, each j-digits binary number or array, not including an “any” digit, can be represented by one node among 2^{j} possible nodes located j levels below the root, and reached by following a path comprising a sequence of diagonally right or left pointers according to the array sequence of binary digits. The last node representing an array is the node reached by the last binary digit before an “any” digit is reached, if “any” digit is included in the array.

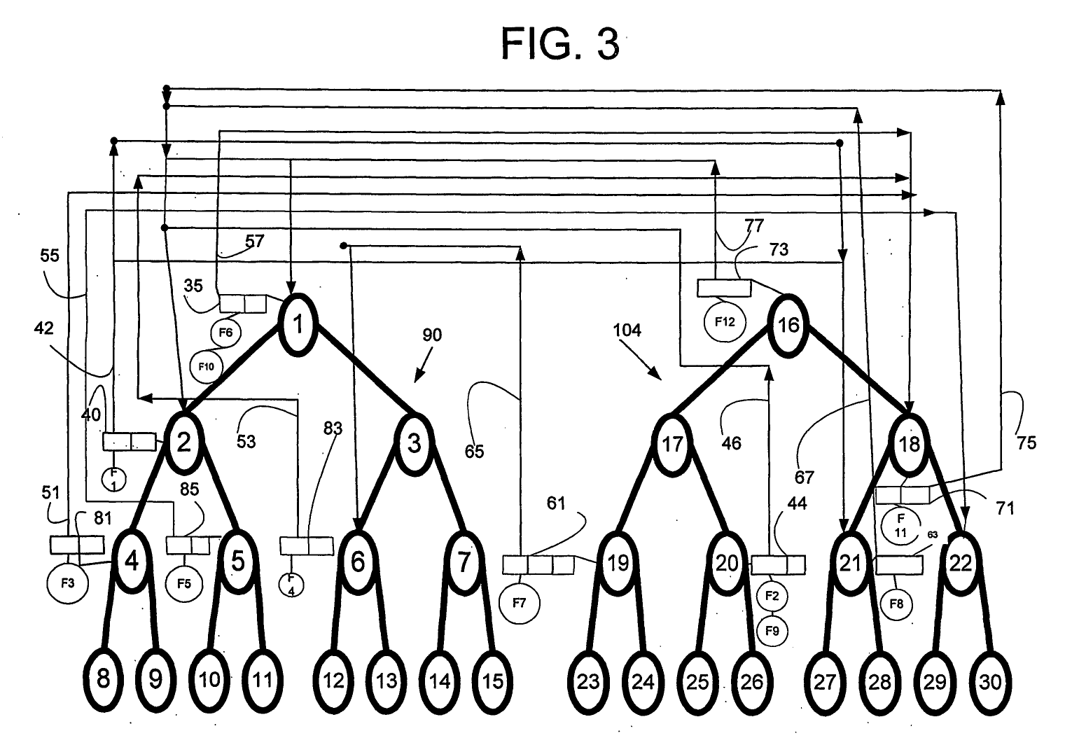

After the first stage of building a BST as was described in FIG. 2, arrays from policy table 110 (FIG. 1) are inserted to BST 100 step-by-step according to the algorithm stages as will be further described in FIG. 3.

As was described above, a binary array may be represented in one of the following ways:

Array including binary digits only, allowing for an exact match only, i.e. an exact match array;

Array including binary digits followed by an “any” digit, allowing for a prefix match, i.e. a prefix match array;

Array including binary digits enclosing an “any” digit, i.e. a range array; and

“Any” without binary digits, i.e. an “any” match.

Each one of the mentioned arrays may form a part of a filter. In the present invention the arrays are implemented by a BST.

A w bits exact match filter is described by a w-th level BST. A w bits prefix array comprising of b binary bits followed by an “any” digit may be described by a b-th level node, or by a single b-binary bits followed by “any” digit. For example, “all the 16 bit numbers below 1024” is represented by a sixth level BST leftmost node 000000*.

A range array can be represented by up to 2*w prefix arrays, as is known. A 16 bits range array such as “all the 16 bit numbers above 1023”, or “above *1111111111”, can be represented by the following six prefix range arrays: 000001*, 00001*, 0001*, 001*, 01*, 1*.

In the present invention, range arrays are replaced by their equivalent prefix arrays before their subsequent handling. Consequently, only “any” match, prefix and exact match arrays are described hereinbelow. As an “any” match array always matches another array, only the handling of prefix match and exact match arrays will be elaborated upon in the following description.

The simplest filter matching procedure is done by sequentially comparing the arrays of the filter to be matched to all of the database filters. This requires time proportional to n*k. For any but a small number of filters, the required processing time is unacceptable. Therefore, a fast method for the initial reduction of the number of filters is required, as described below.

The present invention is particularly useful for the selection of filters represented by array-including filters. The filters may include other elements, used in the handling of IP and other communicated messages. While only IP will be referred to in this detailed description, this invention is readily adaptable by a person skilled in the art to the handling of message headers of other protocols and of array-including filters in general. Also, this invention deals with a fast and an efficient classification method determined only by the binary particulars of the headers; no reference will be made in the exemplary embodiment of this invention to the use of contents in this classification method. However, those skilled in the art will appreciate that methods relying on header particulars and type of contents could be readily combined to form a more comprehensive method.

According to the present invention, it is possible in numerous cases to avoid the need to match many of the filters within a database, by the fast exclusion of most of the filters in an early stage of processing. Further matching in another processing stage may be applied on a small number of filters.

A filter is a list of conditions for the handling of flows. A condition may be expressed by a binary array, with the arrays or conditions arranged in a known sequence. A binary array comprises three representations: binary representations, binary representations and a single “any”, or only of a single “any”. Each one of a filter's conditions matches a corresponding field in a packet header or in a connection's data. It is desired to find the most appropriate filter that matches each handled connection from among the filters that are included in the database and that match a handled connection.

The matching process is carried out in stages. During the matching process the cost of every filter is used for further prioritizing the filters in a list, thus giving a high priority for filters with a low cost (based on the assumption that a filter with a low cost has a higher priority than a filter with a higher cost).

The matching process commences with the first step of the first stage, in which a matching of two arrays of the database filters and the corresponding two arrays in the tested filter takes place. This matching requires the building of a BST, the nodes of each BST representing a particular array of the database filters. These BST need be changed only if the database is changed, such as by adding, removing or changing any of the database filters. Only that group of database filters that matches the combined requirements of the two tested filter arrays is selected for further processing in the next step of the first stage or in the second stage of this invention, excluding the other filters from further handling.

The second step of the first stage is a “filter exclusion” or (“FS”), its purpose is to exclude as many database filters as possible from the second stage matching. A matching of another pair of arrays of group of filters can be done, in a subsequent step, excluding still more filters and leaving a sub-group of filters for further handling.

In the second stage, the remaining fields of the first-stage selected filters are matched in any method such as by sequentially comparing them to the remaining packet header arrays.

The number of selected filters after the first stage is usually much lower than the total number of database filters, and then fewer fields need to be matched in the selected filters, therefore the second stage is performed much faster than the conventional matching of the full database filter.

Once the destination BST of the database filters is established, the time required to match a new array to the database filters and to find the filter or filters that match it, is, at most, the highest number of its levels times a single comparison time. A similar BST may be built for the source BST.

If new filters are added to the database or are deleted from it, updating of the BST representing the respective array is necessary. Updating is done either by adding a filter to the database, by deleting a filter from the database, or by changing one of its fields, followed by correspondingly changing the BST. These operations might change the number of nodes in a BST and the number of its nodes.

The time required for each one of these BST updating operations is:

Ω[log(n)+w]

The algorithm initializing process on two BST composes 3 basic stages as will now be described:

1) finding the matched place in the BST of two different arrays from different actions of the same filter in policy table 110 for example the binary arrays 0* and 10* are actions from the source and destination address of filter F1, and are related to nodes 2 and 21, respectively.

2) query check stage—the algorithm checks if a list of filters is placed already in one of the nodes:

i) if there isn't a list at any of the nodes—a new filter list is created randomly at one of the nodes, placing the filter at the head of the new list and pointing to the node of the other BST (in this example, the left BST 90 is chosen for placing the new list).

ii) if there is a filter list at both of the nodes—the algorithm compares the length of both of the lists and inserts the filter into the shortest list, with a pointer which points to the corresponding node placed at the other BST;

iii) if the length of the lists in both of the nodes is equal, the filter is inserted randomly in one of the lists, with a pointer that points to the node at the other BST (in this example the left BST 90 is chosen randomly).

3) steps 1 and 2 are repeated until all the binary arrays from policy table 110 are inserted in their appropriate nodes at both of the binary BST.

With reference to FIG. 3, there is seen a flowchart of an algorithm used to construct two BST from a policy table 110.

Insertion of F1—the nodes of source address 0* and destination address 10* at the BST 90,104 are checked simultaneously. The path to the matched node of source address 0* at the source BST 90 starts at the root where an “*” is placed 1 and continues down to node 0* 2, simultaneously the destination address is reached at the destination BST 104 starting at the root “*” 16 down and right to node “1* 18, and from there down and left to node 10* 21.

The query stage is executed simultaneously at nodes 21 and 2. Since both of the nodes are empty, a new list 40 is created randomly at node 2, filter F1 is inserted to the head of the new list with a pointer 42 which points to node 21 placed at the destination BST 104.

Insertion of F2—stage 1 of the algorithm is repeated for the insertion of Filter 2, the algorithm checks the content of nodes “0*”2 and “01*” 20, node 2 contains a list while node 20 is empty, as a result the algorithm creates a new list 44 placed at node 20, F2 is inserte to the head of the list with a pointer 46 which points to node 2 placed at the source BST 90.

The insertion process is repeated for the other filters—filters F3, F4 ,F5 F6 are inserted to the head of lists 81,83,85 and 35 placed at nodes 4,6 5 and 1 at the source BST 90, respectively, with pointers 51,53,55 and 57 to nodes 18 and 22 placed at the destination BST 104.

Note, different nodes from the same BST can point to the same node (for example F3 and F4 placed at nodes 4 and 5 at the source BST 90 are both pointing to node 18 placed at destination BST104).

Insertion of F7and F8—the query stage of the algorithm is activated and as a result of the fact that two different lists exist already at nodes *10 and *0 (6 and 2) at the source BST 90, while nodes 00* 10* (19 and 21) at the destination BST 104 are empty—new lists 61 and 63 are created at nodes 19 and 21 with pointers 65 and 67 pointing to nodes 6 and 2.

Insertion of F9 and F10—the matched place for F9 at the BST 100 are nodes 2 and 20.

As the query stage is activated, it is seen that there are existing lists at both of the nodes. As a result of time and place considerations, F9 is added to the list 44 placed at node 20 which points already to node 2.

The matched nodes of F10 at the BST 100 are nodes 1 and 18. Since there are lists at both of the nodes, F10 is inserted to list 35 placed at node 1 which already has a pointer 57 pointing to node 18 according to the algorithm stages as described.

Insertion of F11 and F12—since nodes 1 and 2 at the source BST 90 contain lists while nodes 18 and 16 at the destination BST 104 are empty, new lists 71,73 are created at nodes 18 and 16, and F11 and F12 are inserted to the head of the lists with pointers 75, 77 to nodes 2 and 1, respectively.

F12, as described in this example, substitutes as a fallback filter.

A filter with fields such as “any” to “any” is always needed for a fallback situation, and to avoid a situation where arrays placed in the policy table 110 are not sorted.

Once BST 90 and 104 are established, filter selection and exclusion proceeds as follows.

The Algorithm filter selection (FS) process of matching packet header fields to corresponding database filter fields composes 3 basic stages as will be described hereinbelow:

1) the process begins with the algorithm traversing a path along one of the pair BST, such as the source BST with the source field array of the matched packet, until the last BST node is reached, while marking all of the traversed nodes;

2) the algorithm then traverses a path along the second BST of the pair, such as the destination field array of the matched packet until the last BST node is reached, while marking all of the traversed nodes;

3) the algorithm then makes a list of all the destination field filter pointers originating along the path that reach a marked node in the source BST;

4) the algorithm adds to the list all the source field pointers originating along the path that reach a marked node in the destination BST; and

5) the algorithm chooses one of the filters in the list according to any selectable criteria, such as its cost of use.

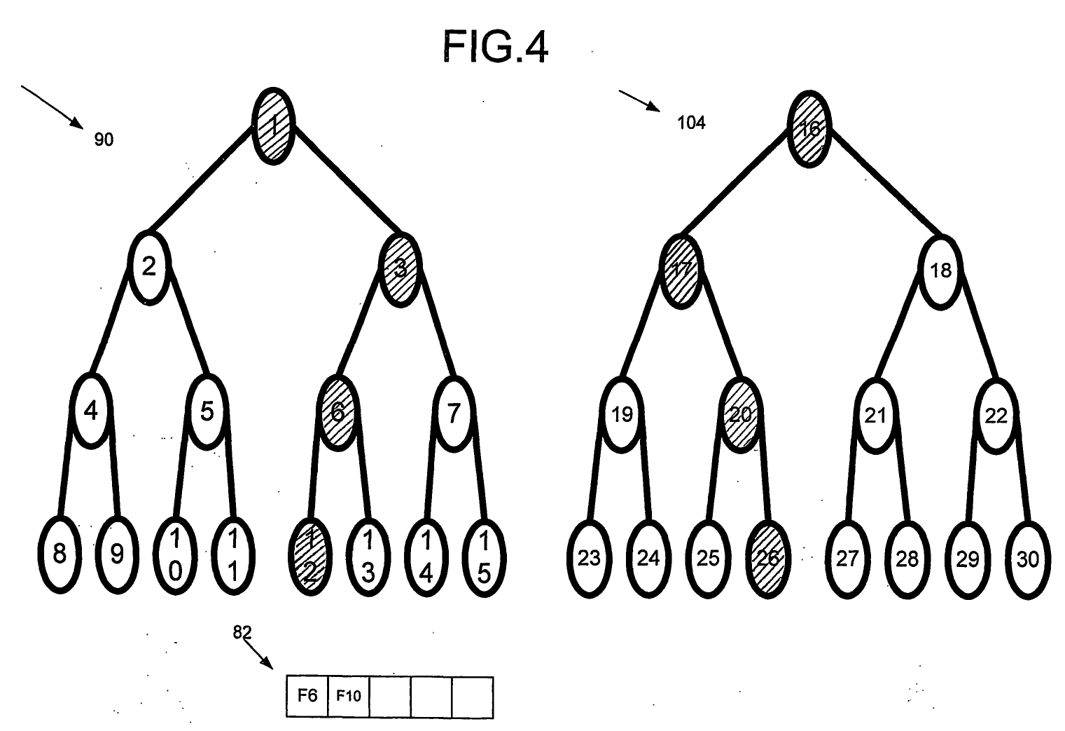

With reference to FIG. 4, there is shown an exemplary embodiment of the filter selection process according to the algorithm stages as described above.

At the beginning of the process, a connection with source address 100* and destination address 011* arrives for further matching and selection.

The marking process starts, and nodes 1, 3, 6 and 12 from the source BST 90 are marked (shown shaded in FIG. 4), in this order, through the path of the source array packet 100*.

In the next stage, the algorithm traverses along the path of the destination array 011* marking all the traversed nodes 16,17,20,26 (shown shaded in FIG. 4) at the destination BST 104 and checking if the pointers point to marked nodes at the source BST 90. If the answer is positive, the filters placed at the marked nodes are inserted to a new list 82 for further selection. Based on the algorithm stages, node 16 is marked, and the pointers of node 16 point to a marked node 1, and as a result, F6 and F10 are added to new list 82. The algorithm process continues, and nodes 17, 20 and 26 are marked.

All of the pointers of the marked nodes placed at the source BST 90 are not pointing to marked nodes, and as result, none of the remaining filters placed at the source BST 90 are added to the new list 82. The filter selection process continues, and nodes 1, 3, 6 and 12 placed at the source BST 90 are checked to determine whether their pointers point to marked nodes placed at the destination BST104.

In the FIG. 4 example, none of nodes 1, 3, 6 and 12 pointers point to marked nodes. At the end of the exemplary FS process, new list 82 contains filters F6 and F10. Based on the assumption that the cost of filters F6 and F10 is graded from the lowest and most important filter to the highest and least important, F6 is placed at the head of the list, followed by F10.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

1. A multi-stage, machine-implemented method for enabling the handling of information flow for classification purposes, by automated selection of the optimally-matched filter including arrays from among a collection of filters in a communications network wherein each filter contains at least two fields, a first field having a plurality of input data, and a second field having a plurality of output data, said method comprising matching attributes of said information with said filter arrays by conducting a search of said collection of filters in accordance with a binary tree algorithm having a minimum of two binary trees, said binary tree algorithm being constructed from a policy table containing a list of related filter arrays arranged in a particular sequence stored in the binary tree nodes, said method proceeding by only one traversal over each binary tree.

2. (Deleted)

3. The method of claim 1, wherein at least some arrays of filters included in said collection of filters conform to at least some arrays of a TCP/IP protocol header associated with said information flow.

4. The method of claim 1, wherein a first and second array of said at least one filter correspond to the source and destination addresses of a TCP/IP protocol header associated with said information flow.

5. The method of claim 1, wherein at least parts of said at least one filter included among said collection of filters conforms to at least parts of a UDP protocol header associated with said information flow.

6. The method of claim 1, wherein a first and second array of said at least one filter correspond to the source and destination addresses of a UDP protocol header associated with said information flow.

7. The method of claim 1, wherein each filter of said list is associated with a cost according to selectable criteria.

8. The method of claim 1, wherein said collection of filters is stored in a computer accessible database.

9. The method of claim 1, wherein said list of related filter arrays may include range arrays, prefix arrays, exact arrays and “any” arrays.

10. A method for filter selection and array matching for handling information flow for classification purposes, comprising the steps of:
i) choosing at least two fields from a list of fields associated with arrays stored in a filter database table;
ii) building two binary trees based on arrays stored in said filter database table, a first binary tree for a source field array and a second binary tree for a destination field array;
iii) storing said arrays of said filters in a suitable node in said binary trees with a pointer for every said node which points to its corresponding array in said parallel binary tree;
iv) traversing a first path along said first binary tree with a source field array of the information flow until the last binary tree node is reached;
v) marking all said traversed nodes of said first binary tree during said one-time traversal;
vi) traversing a second path along said second binary tree with a destination field array of said information flow until the last binary tree node is reached;
vii) marking all of said traversed nodes of said second binary tree during said one-time traversal;
viii) initializing a list of filters having pointers originating along said second path that reached a marked node in said first binary tree;
ix) adding to said list, filters having pointers originating along said first path that reach a marked node in said second binary tree; and
x) arranging said listed filters according to any selectable criteria; and
xi) comparing said listed filters to the information flow by any kind of method.

11. The method of claim 10 wherein another pair of binary trees are built from said first group of filters to form a sub-group of filters, then a sub-sub group and so on.

12. The method for filter selection and array matching according to claim 10 wherein several pairs of binary trees are built from said filter database table.

13. The method of claim 10 wherein said filter database arrays include range arrays, prefix arrays, exact arrays and an “any” array.

14. The method of claim 10 wherein said filter database table contains array conditions and actions.
